(19) United States
(12) Patent Application Publication
(10) Pub. No.: US 2013/0237885 A1
(43) Pub. Date: Sep. 12, 2013

(54) PHYSICAL THERAPY DEVICE

(71) Applicant: Tony Deering, Drumright, OK (US)

(72) Inventor: Tony Deering, Drumright, OK (US)

(21) Appl. No.: 13/413,457

(22) Filed: Mar. 6, 2012

(51) Int. Cl. A61H 1/02

(52) U.S. Cl. 601/40

(57) ABSTRACT

The present invention is a physical therapy device that includes a plate of aluminum, an aluminum base that is perpendicularly attached to the plate of aluminum, a weld that attaches the plate and base together and a plurality of aperture rows that are disposed on the plate of aluminum. The device also includes a plurality of screws and are inserted through the aperture rows disposed on the plate of aluminum, a plurality of locknuts that are twisted onto each screw and a screw driver that includes a distal end with a screw head disposed on the distal end of the screw driver that correspondingly receives and accommodates the screw head of the screws. The user of the device turns and twists the screw driver resulting in a therapeutic strengthening, exercising and rehabilitation of the user's hand, wrist, and forearm.

### TECHNICAL FIELD & BACKGROUND

Those who have sustained considerable injury to their hand, wrist, or forearm may find it difficult to regain their range of motion. There are limited options in effective physical therapy tools geared specifically towards regaining their range of motion.

The present invention generally relates to a therapeutic device. More specifically, the invention is a physical therapy device.

It is an object of the invention to provide a physical therapy device that rehabilitates a plurality of hand and wrist injuries and helps a user regain a relatively greater range of motion.

It is an object of the invention to provide a physical therapy device that is manually operated by a physical therapy patient with a hand, a wrist, or a forearm injury to rotate a series of screws in and out of a plate of aluminum in a redundant fashion helping a user to regain a greater range of motion.

It is an object of the invention to provide a physical therapy device that is a physical therapy tool that is specifically geared toward hand, wrist, and forearm rehabilitation that require continuous smooth rotation.

What is really needed is a physical therapy device that rehabilitates a plurality of hand and wrist injuries and helps a user regain a relatively greater range of motion that is manually operated by a physical therapy patient with a hand, a wrist, or a forearm injury to rotate a series of screws in and out of a plate of aluminum in a redundant fashion helping a user to regain a greater range of motion that is a physical therapy tool that is specifically geared toward hand, wrist, and forearm rehabilitation that require continuous smooth rotation.

### BRIEF DESCRIPTION OF THE DRAWINGS

The present invention will be described by way of exemplary embodiments, but not limitations, illustrated in the accompanying drawings in which like references denote similar elements, and in which:

FIG. 1A illustrates a front view of a physical therapy device, according to an embodiment of the present invention.

FIG. 1B illustrates a side view of a physical therapy device, according to an embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is utilized repeatedly. The phrase generally does not refer to the same embodiment, however, it may. The terms “comprising”, “having” and “including” are synonymous, unless the context dictates otherwise.

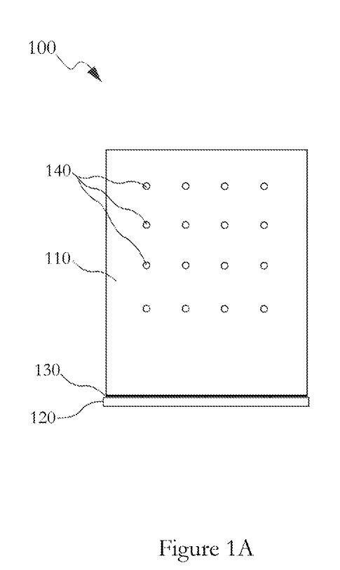

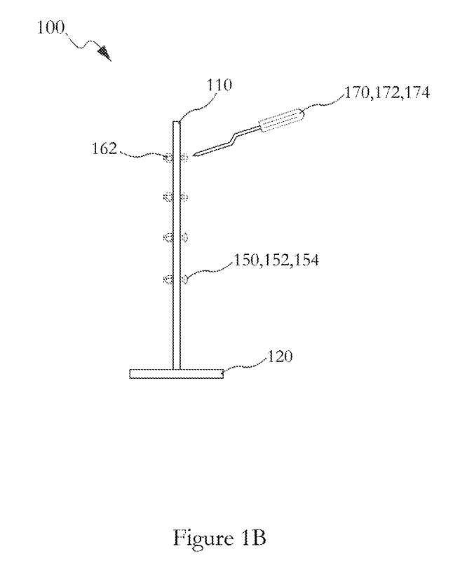

FIG. 1A illustrates a front view of a physical therapy device 100, according to an embodiment of the present invention. The physical therapy device 100 includes a plate of aluminum 110, an aluminum base 120, a weld 130 and a plurality of aperture rows 140. The plate of aluminum 110 is a backing of the physical therapy device 100, although the plate can be made of other suitable materials. The aluminum base 120 is perpendicularly attached to the plate of aluminum 110, although the base can be made of other suitable materials. The weld 130 permanently perpendicularly attaches the plate of aluminum 110 and the aluminum base 120 together. The aperture rows 140 are disposed on the plate of aluminum 110. The aperture rows 140 illustrated are 4 rows and 4 columns forming 16 apertures, although the aperture rows 140 can be any suitable quantity of aperture rows and columns.

FIG. 1B illustrates a side view of a physical therapy device 100, according to an embodiment of the present invention. The physical therapy device 100 illustrated in FIG. 1 A has similar features to the physical therapy device 100 illustrated and described in FIG. 1B such as a plate of aluminum 110, an aluminum base 120, a weld 130 and a plurality of aperture rows 140. Additionally, the physical therapy device 100 includes a plurality of screws 150, a plurality of locknuts 160 and a screw driver 170. The screws 150 have a distal end 152 and a screw head 154 and are inserted through the aperture rows 140 disposed on the plate of aluminum 110. The locknuts 160 are twisted onto each of the distal end 152 of the screws 150 inserted through the aperture rows 140 disposed on the plate of aluminum 110. The screw driver 170 includes a distal end 172 with a screw head 174 disposed on the distal end 172 of the screw driver 170 that correspondingly receives and accommodates the screw head 154 of the screws 150. A user can insert the distal end 172 of the screw driver 170 into the screw head 154 of the screws 150 and turn and twist the screw driver 170 in a clockwise or counterclockwise direction resulting in a therapeutic strengthening, exercising and rehabilitation of a user's hand, wrist, and forearm and that typically require continuous smooth rotation, although other suitable type of usage or rotation of the screw driver 170 can be utilized.

The physical therapy device incorporates continuous smooth rotation and is a better alternative to current similar physical therapy devices available. The physical therapy device utilizes an aluminum plate afforded a series of holes with nuts tack welded on one side. The physical therapy device is relatively easy to operate where an individual utilizes a swivel screwdriver to screw in a plurality of approximately 2″ long screws in a repetitious manner, both clockwise and counter clockwise, manipulating the hand, fingers and wrist of a user. Among those who will find the physical therapy device suitable for rehabilitation and expediting the process of regaining range of motion, are those in the physical therapy profession, the health care industry and everyday physical therapy patients. The physical therapy device features an approximate 9″×9″×¼″ aluminum plate devised for the purpose of assisting physical therapy patients in regaining their range of motion through screwing in approximate 2″ screws into a series of apertures. The base of the physical therapy device is approximately 3″×9″×¼″. The physical therapy device is designed to be relatively durable, easy to use, effective, and to rehabilitate muscles, bones and tendons.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. A physical therapy device, comprising:
a plate of aluminum that is a backing of the physical therapy device;
an aluminum base that is perpendicularly attached to said plate of aluminum;
a weld that attaches said plate of aluminum and said aluminum base together;
a plurality of aperture rows that is disposed on said plate of aluminum;
a plurality of screws that have a distal end and a screw head and are inserted through said aperture rows disposed on said plate of aluminum;
a plurality of locknuts that are twisted onto each said distal end of said screws; and
a screw driver includes a distal end with a screw head disposed on said distal end of said screw driver that correspondingly receives and accommodates said screw head of said screws.

2. The device according to claim 1, wherein said weld is a permanent weld.

3. The device according to claim 1, wherein said aperture rows include 4 rows and 4 columns forming 16 apertures.

4. The device according to claim 1, wherein said locknuts are inserted through said aperture rows disposed on the plate of aluminum.

5. The device according to claim 1, wherein a user inserts said distal end of said screw driver into said screw head of said screws and turns and twists said screw driver in a clockwise or counterclockwise direction.

6. The device according to claim 5, wherein said user turns and twists said screw driver resulting in a therapeutic strengthening, exercising and rehabilitation of said user's hand, wrist, and forearm.

7. The device according to claim 5, wherein said user turns and twists require continuous smooth rotation.

8. A physical therapy device, comprising:
a plate of aluminum that is a backing of the physical therapy device;
an aluminum base that is perpendicularly attached to said plate of aluminum;
a permanent perpendicular weld that attaches said plate of aluminum and said aluminum base together;
a plurality of aperture rows that is disposed on said plate of aluminum;
a plurality of screws that have a distal end and a screw head and are inserted through said aperture rows disposed on said plate of aluminum;
a plurality of locknuts that are twisted onto each said distal end of said screws; and
a screw driver includes a distal end with a screw head disposed on said distal end of said screw driver that correspondingly receives and accommodates said screw head of said screws.

9. The device according to claim 8, wherein said aperture rows include 4 rows and 4 columns forming 16 apertures.

10. The device according to claim 8, wherein said locknuts are inserted through said aperture rows disposed on the plate of aluminum.

11. The device according to claim 8, wherein a user inserts said distal end of said screw driver into said screw head of said screws and turns and twists said screw driver in a clockwise or counterclockwise direction.

12. The device according to claim 11, wherein said user turns and twists said screw driver resulting in a therapeutic strengthening, exercising and rehabilitation of said user's hand, wrist, and forearm.

13. The device according to claim 11, wherein said user turns and twists require continuous smooth rotation.

14. The device according to claim 8, wherein said physical therapy device includes an approximate 9″×9″×¼″ aluminum plate.

15. A physical therapy device, comprising:
a plate of aluminum that is a backing of the physical therapy device;
an aluminum base that is perpendicularly attached to said plate of aluminum;
a permanent perpendicular weld that attaches said plate of aluminum and said aluminum base together;
a plurality of aperture rows that is disposed on said plate of aluminum;
a plurality of screws that have a distal end and a screw head and are inserted through said aperture rows disposed on said plate of aluminum;
a plurality of locknuts that are twisted onto each said distal end of said screws, wherein said locknuts are inserted through said aperture rows disposed on the plate of aluminum; and
a screw driver includes a distal end with a screw head disposed on said distal end of said screw driver that correspondingly receives and accommodates said screw head of said screws, wherein a user inserts said distal end of said screw driver into said screw head of said screws and turns and twists said screw driver in a clockwise or counterclockwise direction.

16. The device according to claim 15, wherein said aperture rows include 4 rows and 4 columns forming 16 apertures.

17. The device according to claim 15, wherein said user turns and twists said screw driver resulting in a therapeutic strengthening, exercising and rehabilitation of said user's hand, wrist, and forearm.

18. The device according to claim 15, wherein said user turns and twists require continuous smooth rotation.

19. The device according to claim 15, wherein said physical therapy device includes an approximate 9″×9″×¼″ aluminum plate and said base is approximately 3″×9″×¼″.

20. The device according to claim 15, wherein said screws are approximately 2″ screws in length.
